(19) United States
(12) Patent Application Publication
(10) Pub. No.: US 2025/0347361 A1
(43) Pub. Date: Nov. 13, 2025

(54) HOLDING ASSEMBLY

(71) Applicant: GRIPPLE LIMITED, Sheffield, South Yorkshire (GB)

(72) Inventors: Simon Davis, Sheffield, South Yorkshire (GB); Thea Bloxham, Sheffield, South Yorkshire (GB)

(21) Appl. No.: 18/871,761

(22) PCT Filed: Jun. 22, 2023
(86) PCT No.: PCT/IB2023/056453

§ 371 Date: Dec. 4, 2024

(30) Foreign Application Priority Data
Jun. 23, 2022 (GB) 2209207.6
Feb. 2, 2023 (GB) 2301489.7
Jun. 21, 2023 (GB) 2309331.3

(51) Int. Cl. F16L 3/10; F16L 3/11

(52) U.S. Cl. CPC F16L 3/1091; F16L 3/11

(57) ABSTRACT

Aspects relate to a holding assembly (200), to a suspension arrangement (1), and to a system. The holding assembly (200) comprises: a fastener (202) configured to engage a suspender (100); a receptacle (204) to which the fastener (202) is mounted and defining a space (208) to receive an article (2) to be held; and a releaser (206) operable to control an engagement of the fastener (202) with the suspender (100) to enable the holding assembly (200) to be positioned along the suspender (100).

### FIELD OF THE INVENTION

Embodiments of the present invention relate to holding assemblies. In particular, but not exclusively, this invention relates to holding assemblies for holding variable refrigerant flow pipes.

### BACKGROUND TO THE INVENTION

A Variable Refrigerant Flow (VRF) system is a heating, ventilation and cooling (HVAC) technology. Refrigerant pipes carry refrigerant between one or more condensing units and a plurality of indoor units, each responsible for a particular zone. The use of multiple small indoor units enables the use of multiple small-diameter refrigerant pipes, rather than large-diameter ducts.

VRFs often come in two pipe systems or three pipe systems. In a typical two-pipe system, all zones must be in cooling or all in heating. A three-pipe system, or a two-pipe system with a branch circuit controller, provides the ability to simultaneously heat certain zones while cooling others.

Refrigerant pipes such as VRF pipes are often suspended from roofs or ceilings by a suspension means, as well as other building services such as electrical power cables or data cables. However, the installation of the suspension means can be expensive and time consuming. During installation, a drop may be desired for various reasons such as promoting gravity flow, avoiding other ceiling services, or compensating for the unevenness of the ceiling. In order to incorporate the drop, the installer may need to order parts of the suspension means in pre-set sizes/drop lengths.

### BRIEF DESCRIPTION OF VARIOUS EMBODIMENTS OF THE INVENTION

According to an aspect of the invention there is provided a holding assembly comprising:
a fastener configured to engage a suspender (e.g., elongate suspender);
a receptacle to which the fastener is mounted and defining a space to receive an article to be held; and
a releaser operable to control an engagement of the fastener with the suspender to enable the holding assembly to be positioned along the suspender.

This provides the advantage that the installer is provided with the ability to rapidly adjust the height of the holding assembly relative to the suspender. This can be done while the receptacle is empty or loaded.

The fastener may be receivable in a hole defined by the suspender. The fastener may be in the form of a plug for insertion into the hole.

The suspender may be in the form of an upright hanging suspender for hanging from a surface such as a ceiling. The fastener may be configured to engage the upright hanging suspender.

The releaser may be a hand-operable actuator. The releaser may be a finger-operable actuator. For example, the releaser may be in the form of a button. An advantage is that the receptacle can be very rapidly repositioned which is useful when setting a precise drop. A button is particularly useful because it is easy to operate with gloved hands, and because it is not a separate component which can be dropped. However, in alternative implementations, the hand-operable releaser may be in the form of a slider, lever, thumb screw head, or wing screw head. In any case, an advantage is that tools are not required, which obviates the risk of an installer dropping a tool from height.

The releaser may be push-to-disengage and release-to-engage. Therefore, when the releaser is pushed by a user's finger in use, the fastener is disengaged from the suspender.

The receptable may be substantially U-shaped. The space defined by the receptacle may be substantially U-shaped.

The article received by the holding assembly may be an elongate article. The elongate article may be a pipe, such as a fluid pipe. The pipe may be an insulated fluid pipe. The pipe may be a variable refrigerant flow (VRF) pipe. The space defined by the receptacle may be sized to support an elongate article at least approximately two inches in diameter. Many insulated VRF pipes are two inches in diameter, or smaller. The width of the space may be at least approximately two inches.

The height of the space may be at least approximately two inches. This enables a single elongate article having a diameter of approximately two inches, to be supported. In some examples, the height of the space may be at least approximately four inches or at least approximately six inches. This enables elongate articles to be stacked. For example, this enables a pair of elongate articles or three elongate articles, each having a diameter of approximately two inches, to be vertically stacked in the space of the receptacle. Vertical stacking minimises the cantilever bending moment applied to the suspender, compared to laying articles horizontally side-by-side. In an example, the two-inch version can support pipe or line sets up to a two inch outside diameter, and the six inch hanger can support multiple pipes or line sets in a stacked position with each pipe or line set having a maximum two inch outside diameter.

Although configured for use with VRF pipes, the holding assembly may optionally be used to support other elongate articles such as cables in addition to, or instead of VRF pipes.

The receptacle may be formed from a plastics material, deformed or moulded to a shape defining the space. The plastics material may be deformed or moulded to the substantially U-shaped shape as described above.

The receptacle may comprise a top opening to receive the article. The top opening may enable the article to be lowered through the top opening into the receptacle.

The holding assembly may comprise a gate to allow the article to be received in the space defined by the receptacle. The gate may cover the top opening of the receptacle.

The gate may be movable in a substantially horizontal direction. This reduces the clearance requirements above the holding assembly. Therefore, the holding assembly can be installed close to a ceiling or soffit.

The gate may be pivotally connected to the receptacle. The gate may be pivotable about a vertical axis. The vertical axis may be substantially parallel to the suspender. The gate may be pivotally connected to a top of the receptacle. The gate may be pivotally connected to the top of the U-shaped receptacle.

A first end of the gate may be rotatably connected to a first upright limb of the receptacle, and a second end of the gate may be releasably connected to a second upright limb of the receptacle.

Each end of the gate may be connected or connectable to the receptacle via a respective gate post. The gate may be rotatable about a first of the gate posts.

The gate may be slidably engageable with and slidably disengageable from the receptacle via one of the gate posts. The gate may be slidably engageable with and slidably disengageable from the receptacle via each of the gate posts.

The gate may be slidably engageable with and slidably disengageable from the receptacle by pivoting the gate about a first one of the gate posts so that a second one of the gate posts is engaged with a slot.

The gate may be in the form of a plate.

The gate may comprise a suspender opening through which the suspender can extend. The suspender opening may be in the form of a slot. The suspender opening may be proximal to a slot for one of the gate posts, and facing an opposite direction than said slot. Therefore, in use, the suspender in the suspender opening of the gate prevents said slot from being disengaged from the proximal gate post.

The receptacle may comprise a first upright limb and a second upright limb. The first upright limb and second upright limb may be connected by a rounded portion. The combination of the first upright limb, the second upright limb, and the rounded portion, may form a U-shape. The combination of the first upright limb, the second upright limb, and the rounded portion, may define the space for receiving the article.

The first upright limb, the second upright limb, and the rounded portion, may be integral portions of a same body. They may be the result of deforming or moulding the body into the substantially U-shaped shape as described above.

The receptacle may comprise a suspender channel. The suspender channel may be an upright suspender channel. The suspender channel may be an elongate suspender channel. The suspender channel may be vertical over at least part of its length. The suspender channel may be straight over at least part of its length. The suspender opening of the gate may be aligned with the suspender channel.

The first upright limb of the receptacle may comprise the suspender channel, enabling the suspender to extend along and inside the first upright limb. The suspender channel may be open at a top aperture of the first upright limb. An advantage of the suspender extending along and inside the first upright limb is that the cantilever span of the holding assembly is minimised compared to an implementation in which the first upright limb is adjacent the suspender.

The suspender channel may comprise a base surface. The suspender channel may comprise left and right side surfaces adjacent the base surface. Therefore, the suspender channel may be at least partially enclosed. The left and right side surfaces may be perpendicular to the base surface.

The receptacle may comprise an inner surface defining the space and an outer surface. The inner surface may be a smooth surface. The outer surface may be a ribbed outer surface.

The receptacle may comprise a plurality of reinforcing ribs. The outer surface may comprise the reinforcing ribs. A left reinforcing rib of the receptacle may provide the left side surface of the suspender channel. A right reinforcing rib of the receptacle may provide the right side surface of the suspender channel. An advantage of the reinforcing ribs is maximising the stiffness and strength of the holding assembly to enable heavy VRF pipes to be carried.

Left and right reinforcing ribs may be present at the first upright limb, at the rounded portion, and at the second upright limb. The receptacle may comprise at least four parallel reinforcing ribs including the left and right reinforcing ribs.

The receptacle may further comprise at least one transverse rib interconnecting two or more of the plurality of reinforcing ribs. A transverse rib may be provided at one or more or each of the first upright limb, the rounded portion, and the second upright limb.

The suspender channel may comprise a closed channel section into which the fastener can extend. The closed channel section may limit the freedom of movement of the receptacle. The closed channel section may prevent translation of the receptacle in a direction perpendicular to the suspender. The closed channel section may limit movement of the receptacle to translation along the suspender. The closed channel section may be accessible through the top aperture as described above.

The suspender channel may comprise an open channel section to enable the suspender to exit the suspender channel. The open channel section may be below the closed channel section. The open channel section may extend from the first upright limb of the receptacle and along the rounded portion of the receptacle, wherein the rounded portion curves away from the first upright limb so that in use, the suspender, which is straight/straighter, exits the suspender channel through the curved part of the open channel section.

The fastener may be located at the first upright limb of the receptacle. The fastener may be positioned along the suspender channel. The releaser may be operable to move the fastener into and out of the suspender channel to control the engagement of the fastener with the suspender. The fastener may be movable into and out of the suspender channel through a hole, such as a slotted hole, in the base surface of the suspender channel.

The releaser may be operable to move the fastener into and out of the closed channel section of the suspender channel. The releaser may be operable to move the fastener in a lateral direction relative to an upright direction of the first upright limb/suspender channel. The lateral direction may be horizontal.

The fastener may be located at a top region or a bottom region of the first upright limb of the receptacle. Therefore, the receptacle protrudes from the suspender in a cantilevered manner. The fastener may be closer to a top end of the suspender channel than a bottom end of the suspender channel, or the fastener may be closer to a bottom end of the suspender channel than a top end of the suspender channel. The suspender channel may extend beneath or above the fastener.

In use, the suspender may pass between the releaser and the fastener. The suspender channel may be between the releaser and the fastener. The releaser may be operable to move the fastener into and out of the suspender channel.

The releaser may be to an exterior side of the receptacle whereas the space for receiving the article may be to an interior side of the receptacle.

The releaser may be located at the first upright limb of the receptacle. The releaser may be connected to the first upright limb of the receptacle.

The receptacle may comprise a releaser carrier for housing the releaser. The first upright limb may comprise the releaser carrier. If the releaser is a button, the releaser carrier may be in the form of a button carrier. The releaser may be movable within the releaser carrier to move the fastener. The releaser carrier may cover the suspender channel to define, at least in part, the closed channel section of the suspender channel.

The holding assembly may comprise urging means to urge the releaser to a position at which the fastener is engaged with the suspender. The urging means may be in the form of a spring such as a compression spring. The compression spring may be a coil spring. The urging means may comprise a plurality of compression springs. The releaser carrier may comprise spring seats for the compression spring(s).

The releaser may be directly connected to the fastener. A release shuttle may provide the releaser and the fastener. The release shuttle may be housed by the releaser carrier.

The release shuttle may comprise a releaser portion and a fastener portion. The releaser portion may be upright and the fastener portion may extend transverse to the releaser portion. The fastener portion may be generally perpendicular to the releaser portion.

The release shuttle may be in the form of a plate such as an angled plate. The fastener portion may be a first leg of the release shuttle and the releaser portion may be a second leg of the release shuttle.

The releaser portion of the release shuttle may be exposed at an opening of the releaser carrier to provide a button surface. The urging means may connect to the releaser portion.

The fastener portion of the release shuttle may comprise the fastener. If the fastener is a plug, the direction of the plug can depend on whether the releaser is push-to-release or pull-to-release. In an implementation, the releaser is push-to-release, and the fastener portion comprises a hole through which the suspender can extend, wherein the hole may be shaped to define the plug. For example, the hole may be C-shaped to define the plug.

According to an aspect of the invention the holding assembly is a variable refrigerant flow (VRF) pipe hanger.

According to an aspect of the invention there is provided a suspension arrangement comprising a holding assembly as described above, and the suspender as described above on which the holding assembly is suspendable.

The holding assembly may be attachable to the suspender.

The suspender may be elongate. The suspender may define at least one hole to which the fastener is engageable. The suspender may define a plurality of the holes. The suspender may be formed from a metals material.

The suspender may comprise an elongate main portion. The main portion may be in the form of a substantially flat strip. The main portion may define the, or each, hole.

The suspender may have a mounting portion for mounting the suspension article on a raised structure, such as a roof beam or ceiling. The mounting portion of the suspension article may extend transverse to the main portion.

The main portion of the suspender may have a longitudinally extending main axis. The main portion may have an elongate central region extending along the main axis. The central region may have a curvature. The central region may be curved about said main axis.

The main portion of the suspension article may have an elongate edge portion extending along the central region. The edge portion may be thicker than the central region. The edge portion may be folded to form a hemmed edge region of the main portion.

The main portion may have two of the edge portions arranged on opposite sides of the central region. Each of said edge portions may be folded to form respective hemmed edge regions of the main portion.

The holes may be arranged one after another along the main portion. The holes may be arranged in a series. The holes may be arranged one after another along the central region of the main portion. The, or each, hole may be a slot. The, or each, hole is larger than the fastener of the holding assembly.

The suspender and the holding assembly may each be shaped to enable the holding assembly to be attached to the suspender regardless of whether the holding assembly is facing a first direction or a second opposite direction. That is, the suspender may be ambidextrous.

According to an aspect of the invention there is provided a system comprising the suspension arrangement as described above, and a VRF pipe carried by the holding assembly.

According to an aspect of the invention there is provided the suspension arrangement as described above, and further comprising a second holding assembly attached to the same suspender. An advantage is a modular capability because the suspender can be shared. The holding assembly and the second holding assembly may each be suspended from a same side of the suspender and vertically separated from each other. Alternatively, the second holding assembly may be suspended from an opposite side of the suspender. The second holding assembly may be the same type of holding assembly, or a different type of holding assembly such as a tray holder.

In other implementations of the gate, the gate may vary in one or more of the following ways: the gate may be movable in a substantially vertical direction; the gate may be pivotable about a vertical axis; the gate may be of a wire form; one end (rather than each end) of the gate may be connected or connectable to the receptacle via one or more gate posts.

Further, in some implementations, the width of the space may be at least approximately three inches.

### BRIEF DESCRIPTION OF THE DRAWINGS

For a better understanding of various examples of embodiments of the present invention reference will now be made by way of example only to the accompanying drawings in which:

FIG. 1 illustrates a perspective view of a suspension arrangement;

FIG. 2 illustrates a perspective view of a holding assembly of the suspension arrangement of FIG. 1;

FIG. 3 illustrates a second perspective view of the suspension arrangement of FIG. 1;

FIG. 4 illustrates an exploded view of the holding assembly of FIGS. 1-3;

FIGS. 5A-5B illustrate side cross-section views of the holding assembly of FIGS. 2-4, showing depressed and non-depressed positions of the releaser;

FIG. 6 illustrates a perspective view of a side cross-section of a receptacle of the holding assembly of FIGS. 2-5B;

FIG. 7 illustrates a perspective view of a suspension arrangement comprising a taller holding assembly than the one shown in FIGS. 1-6;

FIG. 8 illustrates a perspective view of another example suspension arrangement; and

FIG. 9 illustrates a perspective view of an alternative gate.

### DETAILED DESCRIPTION OF VARIOUS EMBODIMENTS OF THE INVENTION

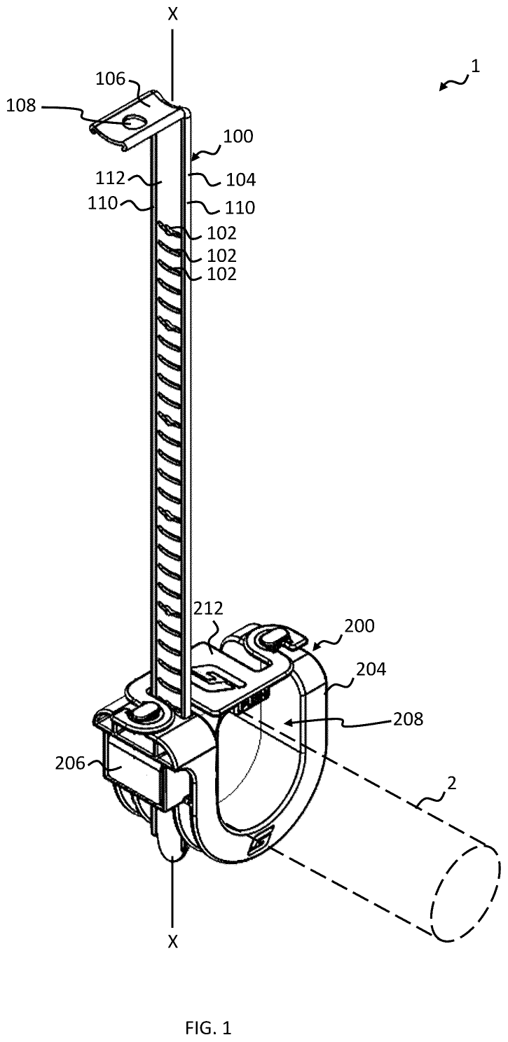

The drawings show a suspension arrangement 1 comprising a holding assembly 200 and a suspender 100. The holding assembly 200 holds an article 2. The article 2 is elongate and may be in the form of a VRF pipe. FIG. 1 illustrates the VRF pipe in dashed lines. Most insulated VRF pipes have an outside diameter of approximately two inches or less. It would be appreciated that pipes and/or cables of different types/diameters could be received, and use is not restricted to VRF pipes.

Referring to FIG. 1, one holding assembly 200 is shown suspended from the suspender 100 to form the suspension arrangement 1. The suspender 100 comprises an elongate main portion 104 in the form of a substantially flat strip. The suspender 100 further includes a mounting portion 106 for mounting the suspender 100 on a raised structure (not shown), such as a roof beam or ceiling.

A plurality of the suspension arrangements 1 may be arranged in a row spaced from each other, wherein the elongate article 2 extends across all the suspension arrangements 1. Each suspension arrangement 1 comprises one of the holding assemblies 200 suspended from a respective suspender 100.

The mounting portion 106 extends transverse to the main portion 104, for example at a right angle to the main portion 104. The mounting portion 106 defines a mounting hole 108 through which a screw or nail can be inserted to mount the suspender 100 on the raised structure.

The main portion 104 has a longitudinally extending main axis X-X. An elongate central region 112 of the main portion 104 extends along the main axis X-X, and is curved about the main axis X-X.

The main portion 104 has opposite elongate edge regions 110 extending along the central region 112. Each of the opposite edge regions 110 of the main portion 104 is folded to form a hemmed edge. The combination of the curved main portion 104 and hemmed edge region 110 provide stability and strength to the suspender 100.

The suspension member defines a plurality of holes in the form of slots 102. Each slot 102 extends across the central region 112 of the main portion 104. The slots 102 are arranged one after another along the central region 112. The purpose of the slots 102 in the central region 112 of the main portion 104 is explained below.

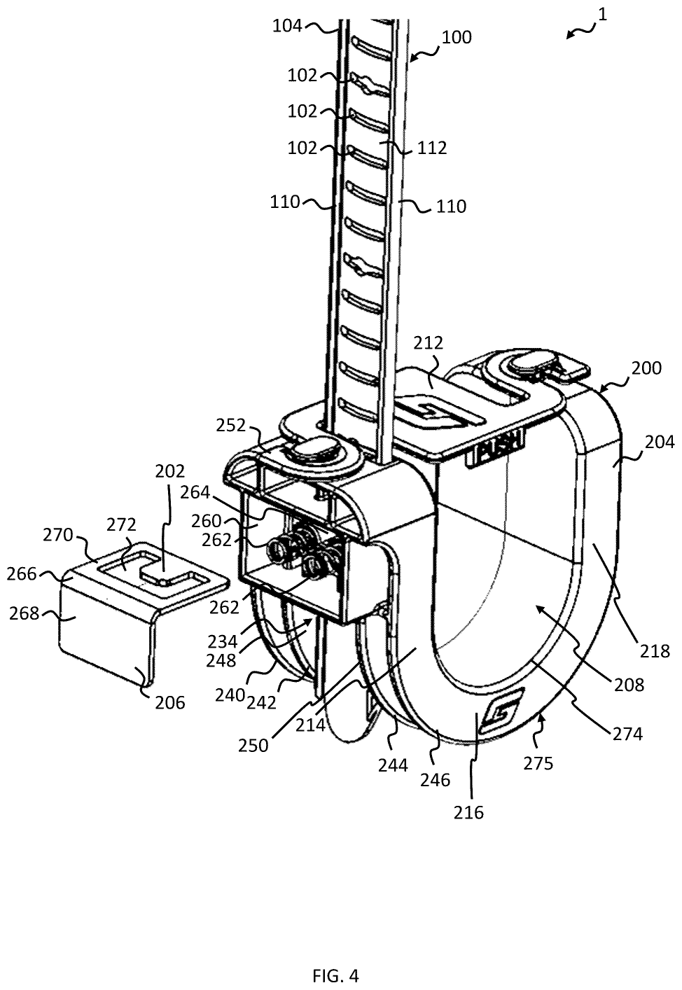

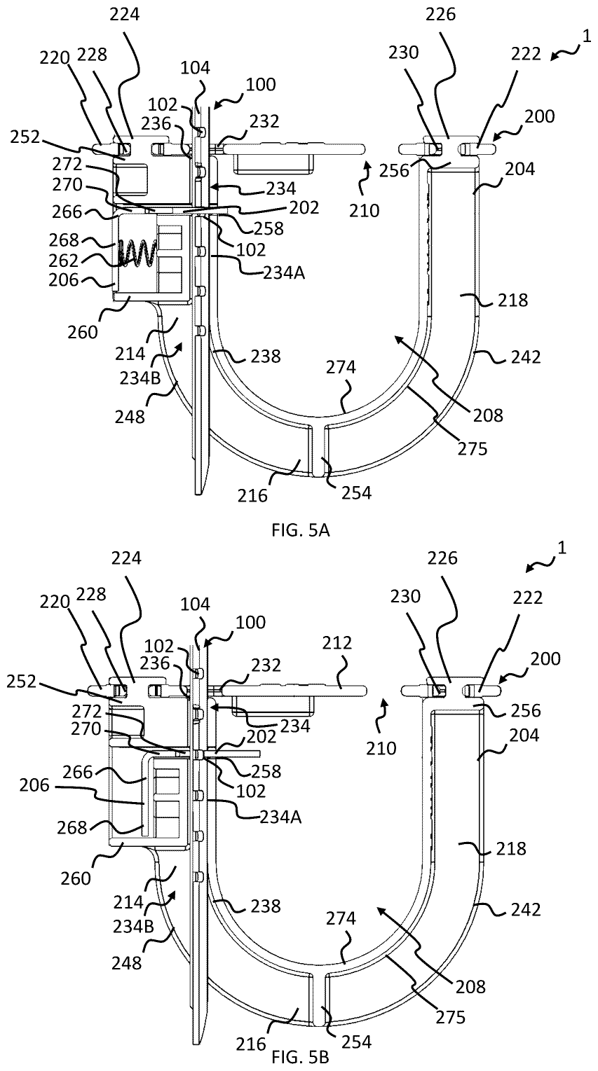

The holding assembly 200 comprises a receptacle 204 to which a fastener (visible as a plug 202 in FIGS. 4-5B) is mounted, wherein the receptacle 204 defines a space 208 to receive the article 2, and wherein the plug 202 is configured to engage any of the slots 102 in the central region 112 of the main portion 104 of the suspender 100. The plug 202 can be moved through one of the slots 102 to attach the holding assembly 200 to the suspender 100. The plug 202 can be moved out of the slot 102 to detach the holding assembly 200 from the suspender 100.

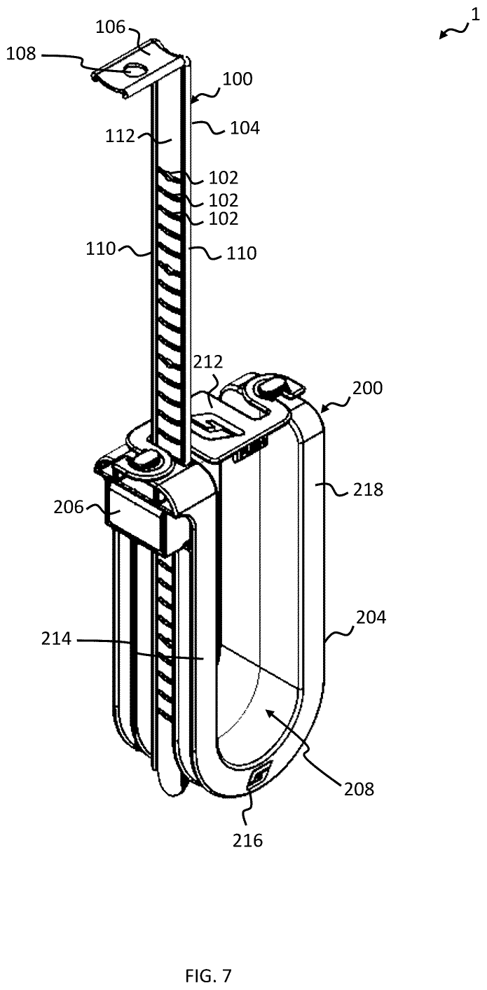

The receptacle 204 is substantially U-shaped, to define a U-shaped space 208 to receive the article 2. In the shorter embodiment of FIGS. 1-6, the space 208 has a height suitable for a single article of two-inches outside diameter, so the height of the space 208 is a value selected from the range two inches to less than five inches. In the taller embodiment of FIG. 7, the space 208 has a height suitable for a stack of three articles (not shown) each of two-inches outside diameter, so the height of the space 208 is a value selected from the range six inches to less than ten inches.

The U-shaped receptacle 204 comprises a first upright limb 214, a second upright limb 218 parallel to the first upright limb 214, and a semicircular rounded portion 216 connecting the bottoms of the first and second upright limbs 214, 218, to define the U-shaped receptacle 204.

The rounded portion 216 provides a saddle on which the article 2 can rest. The inside diameter of the rounded portion 216 can be substantially the same as the outside diameter of the article 2. A width dimension of the rounded portion 216 is at least two inches or approximately equal to two inches. The width dimension of the rounded portion 216 is defined as the dimension parallel to the direction in which the elongate article 2 extends. Although the width of the space 208 could be twice or three times the pipe diameter, this would considerably increase the cantilever bending moment on the suspender 100.

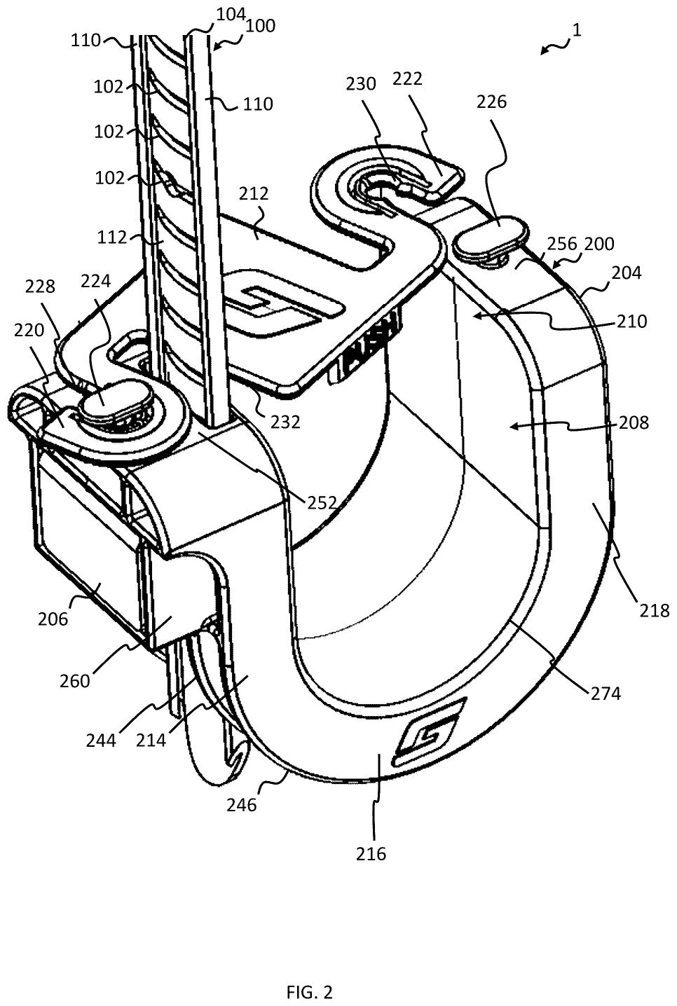

As shown in FIGS. 2, 5A-5B and 6, the U-shaped receptacle 204 comprises a top opening 210 through which the article 2 can be lowered. The width of the top opening 210 may be equal to the width of the space and/or may be at least approximately two inches. This enables the article 2 to be lowered into the space 208.

The receptacle 204 is formed of a suitable plastics material to allow the receptacle 204 to be moulded or deformed to the U-shaped shape defining the U-shaped space 208. The receptacle 204 may be a single body integrally defining the first upright limb 214, the rounded portion 216, and the second upright limb 218. The receptacle 204 has an interior side defining the boundary of the space 208, and an exterior side.

The interior side of the receptacle 204 comprises an inner surface 274. The inner surface 274 of the receptacle 204 may be a smooth surface. The inner surface 274 may be a continuously smooth surface from the first upright limb 214, through the rounded portion 216, to the second upright limb 218. The height of the space 208 as described above is defined as the vertical distance from the top opening 210 to the inner surface 274 at the lowest part of the rounded portion 216.

The exterior side of the receptacle 204 also provides a releaser in the form of a push-to-release button 206, which is finger-operable to control the engagement of the fastener 202 with the suspender 100 to enable the holding assembly 200 to be positioned and repositioned along the suspender 100.

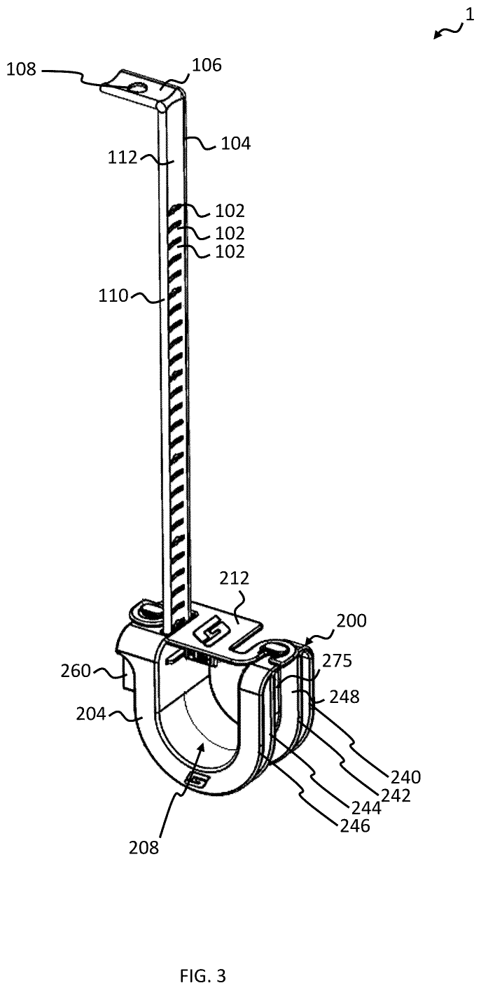

As shown most clearly in FIGS. 3, 4, and 6, the exterior side of the receptacle 204 further comprises a ribbed outer surface 275. The outer surface 275 comprises parallel reinforcing ribs 240, 242, 244, 246. The reinforcing ribs 240, 242, 244, 246 extend, continuously or discontinuously, down from the top of the first upright limb 214, through the rounded portion 216, and up to the top of the second upright limb 218.

The parallel reinforcing ribs 240, 242, 244, 246 are interconnected by a first transverse rib 252 at the top of the first upright limb 214, by a second transverse rib 254 at the bottom of the rounded portion 216, and by a third transverse rib 256 at the top of the second upright limb 218.

As shown most clearly in FIG. 2, the top opening 210 of the receptacle 204 is covered by a movable gate 212 of the holding assembly 200. The gate 212 can swing in a substantially horizontal direction, about a vertical axis parallel to the X-X axis, to minimise the vertical clearance required above the gate 212.

The gate 212 is in the form of a plate shaped to engage with gate posts 224, 226. A first end 220 of the gate 212 is hook-shaped to provide a first slot 228 which is connectable to a first gate post 224. The first gate post 224 is at the top of the first transverse rib 252 at the top of the first upright limb 214. Alternatively, the first end 220 of the gate 212 can comprise the first gate post 224 and the top of the first transverse rib 252 can comprise the first slot 228.

A second, opposite end 222 of the gate 212 is hook-shaped to provide a second slot 230 which is connectable to a second gate post 226 at the top of the third transverse rib 256 at the top of the second upright limb 218. Alternatively, the second end 222 of the gate 212 can comprise the second gate post 226 and the top of the third transverse rib 256 can comprise the second slot 230.

The illustrated hook-shaped ends 220, 222 face opposite directions so the second slot 230 faces the opposite direction than the first slot 228. This limits the chance of detachment of the gate 212 during rotation. Alternatively, they may face the same direction so that the gate 212 can easily be fully detached.

The gate 212 can be unhooked from either the first gate post 224 or the second gate post 226, at the user's choosing, and rotated about the other one of the gate posts 224, 226.

The gate 212 further comprises a suspender opening in the form of a suspender slot 232, through which the suspender 100 can extend. The suspender slot 232 of the gate 212 is proximal to the first slot 228 of the gate 212 and faces an opposite direction than the first slot 228. Therefore, when the gate 212 is closed and the holding assembly 200 is attached to the suspender 100, the gate 212 cannot be released from the first gate post 224 without the suspender 100 abutting the end of the suspender slot 232. Therefore, the gate 212 can only be opened one way when the holding assembly 200 is attached to the suspender 100.

The gate 212 may further comprise an upstand (not shown) at or towards the second end 222, to provide purchase for a user's fingers to push and pull the gate between its open and closed positions.

Turning now to how the button 206 is attached to the receptacle 204, FIGS. 4-5B show that the button 206 is mounted to a releaser carrier, in the form of a button carrier 260. The button carrier 260 has an open face at which a surface of the button 206 is exposed, wherein the button 206 can be depressed (pushed) into the button carrier 260 to move the plug 202. FIG. 5A shows the button 206 in a non-depressed position wherein the plug 202 is engaged with the slot 102 in the suspender 100. FIG. 5B shows the button 206 in a depressed position wherein the plug 202 has been pushed out of the slot 102 in the suspender 100.

The button carrier 260, as well as the reinforcing ribs 240, 242, 244, 246, 252, 254, 256, may be integral parts of the receptacle 204. They may be integral in the sense of being integrally-moulded.

FIGS. 4 and 5A further illustrate urging means in the form of coil springs 262, mounted to spring seats 264 at a base of the button carrier 260, for urging the button 206 back to the non-depressed position. In other examples, a different type of spring may be used.

The exploded view of FIG. 4 illustrates that the button 206 is a face of a release shuttle 266 in the form of an L-shaped plate. A first, transverse leg of the L-shaped plate provides a fastener portion 270 having the fastener 202, and a second, upright leg of the L-shaped plate provides a releaser portion 268 defining the button 206.

The releaser portion 268 is a plate portion having an exposed (exterior-facing) surface defining the button 206, and an opposite interior-facing surface against which the coil springs 262 act.

The fastener portion 270 is a plate portion having a hole 272 through which the suspender 100 can extend. The plug 202 protrudes into the hole 272 so that the hole 272 is C-shaped. The plug 202 is an integral plate portion of the L-shaped plate. The plug 202 is located at the edge of the hole 272 which is distal from the releaser portion 268, and protrudes towards the releaser portion 268.

The suspender 100 passes through the hole 272 of the release shuttle 266. The widest part of the hole 272 is slightly greater than a width of the suspender 100 (defined as the separation of the edge regions 110). The width of the plug 202 is slightly less than the width of the slots 102 so that the plug 202 can be inserted through whichever one of the slots 102 is aligned with the plug 202. For the same reason, the thickness of the plug 202 is slightly less than the heights of the slots 102.

The distance by which the plug 202 protrudes into the hole 272 of the button carrier 260 is slightly less than the distance by which the button 206 can be depressed, so that when the button 206 is fully depressed, the hole 272 has moved enough to fully withdraw the plug 202 from the suspender 100, so that the suspender 100 is aligned with the widest part of the hole 272.

It would be appreciated that the connection between the button 206 and the plug 202 could be different than shown in the FIGS, although the illustrated arrangement is more efficient to manufacture than elaborate mechanism-based solutions and comprises a minimal number of parts.

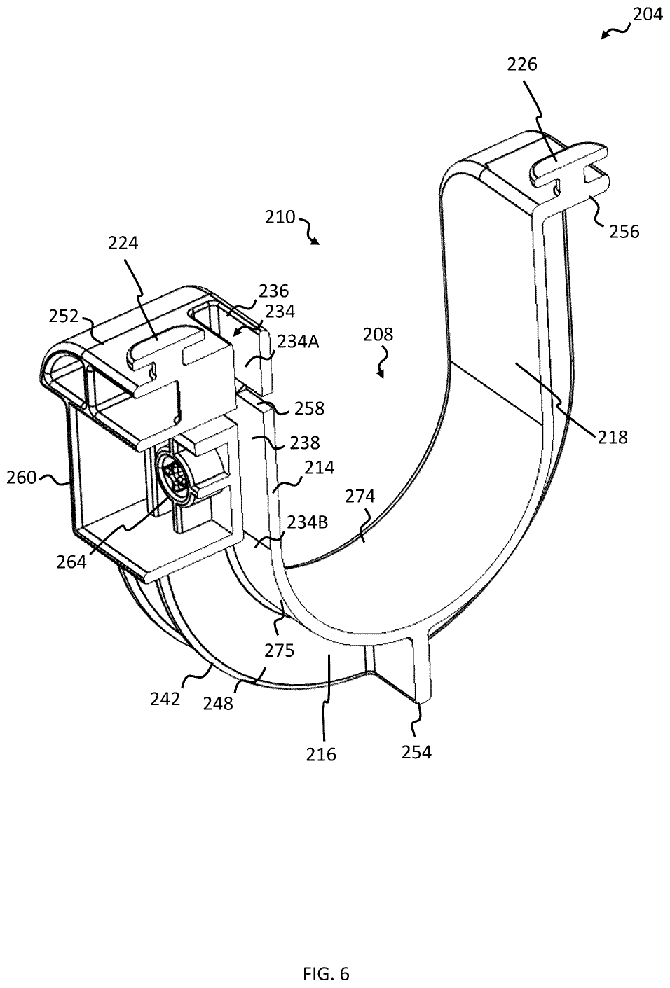

As shown in FIGS. 5A-5B, the suspender 100 extends along a suspender channel 234 within the first upright limb 214. FIG. 6 more clearly shows the suspender channel 234. The suspender channel 234 is defined by a gap between a pair of the parallel reinforcing ribs 242, 244.

The suspender channel 234 enables the suspender 100 to extend along and inside the first upright limb 214 of the U-shaped receptacle 204. The pair of parallel reinforcing ribs 242, 244 define the left and right side surfaces 248, 250 of the suspender channel 234. The base surface 238 of the suspender channel 234 is defined by the part of the outer surface 275 of the receptacle 204 which is between the pair of reinforcing ribs 242, 244.

The suspender channel 234 is accessed from the top of the first upright limb 214 by a top aperture 236 in the first transverse rib 252. FIG. 6 shows the top aperture 236 most clearly. The suspender slot 232 of the gate 212 is also aligned with the top aperture 236 so that the suspender 100 can pass through the suspender slot 232 and the top aperture 236 into the suspender channel 234.

Below the top aperture 236, the suspender channel 234 continues down as a closed channel section 234A which is fully enclosed by a combination of the base surface 238, the left and right side surfaces 248, 250, and a rear surface of the button carrier 260. This prevents lateral movement of the holding assembly 200 during positioning. As shown in FIGS. 5A-5B, the plug 202 is positioned along the closed channel section 234A.

The suspender channel 234 then continues down as an open channel section 234B below the closed channel section 234A. The open channel section 234B curves away from the straight suspender 100 along the rounded portion 216 of the receptacle 204, so that the straight suspender 100 exits the suspender channel 234 via the open channel section 234B. The open channel section 234B terminates at the second transverse rib 254 at the base of the rounded portion 216. The long straight continuous base surface 238, parallel to the main portion 104 of the suspender 100, provides a continuous reaction surface to prevent the holding assembly 200 from rotating under its own weight.

In the shorter embodiment of FIGS. 1-6, the open channel section 234B is shorter than the closed channel section 234A whereas in the taller embodiment of FIG. 7 the open channel section 234B is longer. The total length of the suspender channel 234 depends on the height of the space 208, and may be at least 75% of the height of the space 208.

When the button 206 is depressed, FIG. 5B in combination with FIG. 4 shows that the widest part of the hole 272 of the release shuttle 266 would be aligned with the suspender channel 234, so that the plug 202 does not protrude sufficiently (or at all) into the suspender channel 234. The plug 202 does not prevent sliding of the holding assembly 200 along the suspender 100.

When the button 206 is not depressed, FIG. 5A in combination with FIG. 4 shows that the position of the hole 272 of the release shuttle 266 is such that the plug 202 blocks the suspender channel 234. If a slot 102 of the suspender 100 is aligned with the plug 202, the plug 202 will engage the suspender 100.

Since the plug 202 can block the suspender channel 234, it is recommended that the button 206 should remain depressed while first attaching the holding assembly 200 to the suspender 100, to keep the suspender channel 234 open while feeding the end of the suspender 100 through the suspender channel 234.

In order to prevent a collision between the release shuttle 266 and the base surface 238 of the suspender channel 234, the receptacle 204 comprises a slotted hole 258 through the base surface 238 of the suspender channel 234. The slotted hole 258 opens out to the space 208 of the receptacle 204. The slotted hole 258 is aligned with the fastener portion 270 of the release shuttle 266. The slotted hole 258 has a width and thickness greater than the respective width and thickness of the fastener portion 270 of the release shuttle 266. When the button 206 is depressed, the fastener portion 270 of the release shuttle 266 can slide through the slotted hole 258 without interference. The slotted hole 258 is at least approximately two inches above a bottom of the inner surface 274, to avoid interference with a two inch diameter pipe. When the button 206 is depressed, the distal tip/edge of the fastener portion 270 of the release shuttle 266 extends through the slotted hole 258 and slightly into the space 208. If the slotted hole 258 is not provided, the holding assembly 200 may need to be larger.

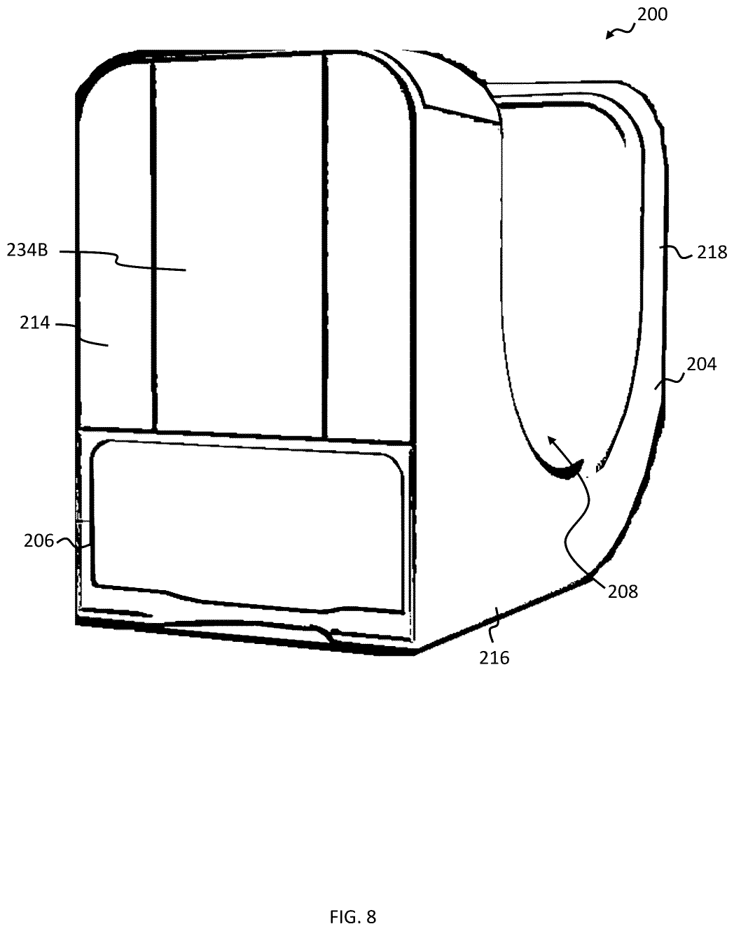

FIG. 8 illustrates an alternative embodiment of the holding assembly 200. The holding assembly 200 of FIG. 8 may have any one or more of the features of the holding assembly 200 of FIGS. 1-7 except where explicitly stated and/or shown to the contrary.

In the example of FIG. 8, the push-to-release button 206 and the associated closed channel section 234A are located below the open channel section 234B, rather than above. The movable gate 212 may be omitted.

An advantage is that the holding assembly 200 can now be pushed up all the way to the ceiling. The button 206 is lower down meaning it is easier to reach.

The button 206 covers the exit of the suspender channel 234. In this example, the release shuttle 266 having the button 206 and the plug 202 is mounted upside down compared to the arrangement shown in FIGS. 4-5B.

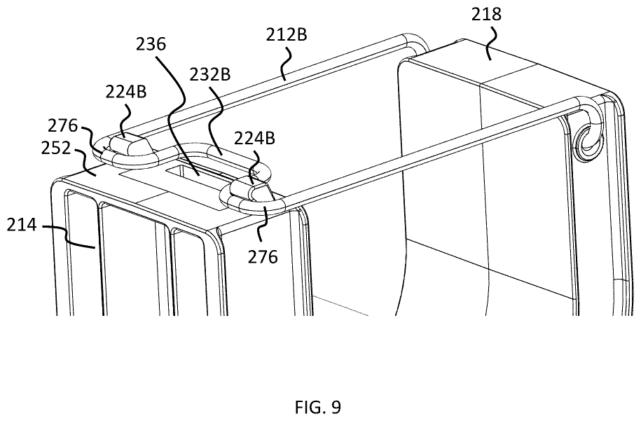

FIG. 9 illustrates an alternative gate 212B. The alternative gate 212B can be used in any implementation. The gate 212B is configured to swing in a substantially vertical direction, about a horizontal axis.

The gate 212B can be formed from a metal material, to increase strength and rigidity. This is useful for higher load applications. For example, if the width of the space 208/rounded portion 216 is greater (e.g., at least or approximately three inches), the gate will have a longer span and therefore would benefit from being more rigid/stronger. As shown, the gate 212B can comprise a wire form, to minimise weight and material usage.

The gate 212B is pivotally secured to the second upright limb 218. The gate 212B is shaped to engage with one or more gate posts 224B. In FIG. 9, gate posts 224B are located at the top of the first transverse rib 252 at the top of the first upright limb 214. The gate posts 224B protrude upwardly and provide hooks to receive the wire form.

The gate 212B and receptacle 204 may be configured to apply a pre-load to retain the gate 212B in the gate posts 224B. Hooking the gate 212B over the gate posts 224B may cause (slight) flexing of the plastics material of the receptable 204.

Alternatively, the direction of the gate may be opposite to that shown, with the gate posts 224B being on the other limb 218.

Where the top aperture 236 for the suspender 100 is closer than the gate posts 224B to where the gate 212B is pivotally secured, the gate 212B comprises a suspender slot 232B to enable the gate 212B to be opened and closed while the suspender 100 extends through the top aperture 236.

In the illustrated example, the gate 212B is a wire form, and comprises a plurality of bends defining a pair of span extensions 276 (one for each gate post 224B), and the suspender slot 232B therebetween.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A holding assembly comprising:
a fastener configured to engage a suspender;
a receptacle to which the fastener is mounted and defining a space to receive an article to be held; and
a releaser operable to control an engagement of the fastener with the suspender to enable the holding assembly to be positioned along the suspender.

2. The holding assembly of claim 1, wherein the releaser is a hand-operable actuator.

3. The holding assembly of claim 1, wherein the releaser is push-to-disengage and release-to-engage.

4. The holding assembly of claim 1, wherein the receptable is substantially U-shaped.

5. The holding assembly of claim 1, wherein the space defined by the receptacle is sized to support the article wherein the article is an elongate article at least two inches in diameter.

6. (canceled)

7. The holding assembly of claim 1, comprising a gate to allow the article to be received in the space defined by the receptacle.

8. The holding assembly of claim 7, wherein the gate is pivotally connected to the receptacle.

9. (canceled)

10. The holding assembly of claim 1, wherein the receptacle comprises a suspender channel.

11. (canceled)

12. The holding assembly of claim 10, wherein the receptacle comprises a first upright limb and a second upright limb, and wherein the first upright limb of the receptacle comprises the suspender channel, enabling the suspender to extend along and inside the first upright limb.

13. The holding assembly of claim 10, wherein the fastener is positioned along the suspender channel.

14. The holding assembly of claim 13, wherein the releaser is operable to move the fastener into and out of the suspender channel to control the engagement of the fastener with the suspender.

15. The holding assembly of claim 1, wherein in use, the suspender passes between the releaser and the fastener.

16. The holding assembly of claim 1, wherein the releaser is to an exterior side of the receptacle whereas the space for receiving the article is to an interior side of the receptacle.

17. The holding assembly of claim 1, comprising a spring to urge the releaser to a position at which the fastener is engaged with the suspender.

18. The holding assembly of claim 1, wherein the releaser is directly connected to the fastener, and wherein a release shuttle provides the releaser and the fastener.

19. (canceled)

20. A suspension arrangement comprising the holding assembly and the suspender on which the holding assembly is suspendable, each as claimed in claim 1.

21. (canceled)

22. The suspension arrangement of claim 20, wherein the suspender defines at least one hole to which the fastener is engageable.

23. The suspension arrangement of claim 20, wherein the suspender and the holding assembly are each shaped to enable the holding assembly to be attached to the suspender regardless of whether the holding assembly is facing a first direction or a second opposite direction.

24. (canceled)

25. A system comprising the suspension arrangement as claimed in claim 20, and a variable refrigerant flow pipe carried by the holding assembly.

26. The holding assembly of claim 1, wherein the releaser is a hand-operable actuator, wherein the receptacle comprises a first upright limb and a second upright limb, and wherein the fastener is located at the first upright limb of the receptacle such that in use the receptacle protrudes from the suspender in a cantilevered manner.
